(19) United States
(12) Patent Application Publication
(10) Pub. No.: US 2011/0078116 A1
(43) Pub. Date: Mar. 31, 2011

(54) METHOD FOR CONTROLLING THE DISTRIBUTION OF DATA BLOCKS AND APPARATUS FOR THE SAME

(75) Inventors: Xiaobing Zhang, Shanghai (CN); Xin Yao, Shanghai (CN)

(73) Assignee: SYNACAST COMPUTER SYSTEM (SHANGHAI) CO., LTD., Shanghai (CN)

(21) Appl. No.: 12/894,082

(22) Filed: Sep. 29, 2010

Related U.S. Application Data
(60) Provisional application No. 61/247,291, filed on Sep. 30, 2009.

(51) Int. Cl. G06F 17/30; G06F 15/16

(52) U.S. Cl. 707/640; 709/203; 709/219; 707/E17.007

(57) ABSTRACT

Methods of and apparatuses for controlling the distribution of data block in a peer-to-peer network and adjusting the distribution of data block in an user equipment end are provided. The system disclosed herein is able to calculate and evaluate the usage of the stream data block based on the present distribution of the data block. The backup of the data block is able to be adjusted, such as increasing the number of backups or deleting the files or backups based on the usage of the files, so that the system resource is able to be optimized. This method can provide high concurrent and efficient customer service capability and highly improve the usability and reliability of the stream media data.

### TECHNICAL FIELD

The present invention relates to methods of and apparatuses for controlling the distribution of data blocks in peer-to-peer networks. Specifically, the present invention is related to methods of and apparatuses for controlling the distribution of media data blocks of video streams.

### BACKGROUND OF THE INVENTION

Along with the improvement of network technology, Video-on-Demand (VoD) service for video stream media is provided on internet nowadays. People can watch programs provided by service provider at anytime. Either Client/Server or P2P (Peer-to-Peer) mode is used in most existing stream media services.

In traditional Client/Server mode, programs are stored in a stream media server. When user watches a program, a command is sent from a user equipment to a stream media server first, and then the data blocks of the program are obtained from the stream media server. This mode has a heavy demand on the bandwidth and storage of the stream media server. Furthermore, along with the increase of the users, the stream media server consumes more internet resource. This networking mode limits the growth of the number of user equipments.

The P2P mode has overcome the above deficiencies of the Client/Server mode. When user watches a program, a command is first sent from an user equipment to a stream media server or to other user equipments, and then the data blocks of the program are obtained from the stream media server or the other user equipments. In another words, P2P mode allows the user equipment to skip the service provider and connect to other user equipments to interchange data blocks or other information directly. This mode makes the internet ‘uncentralized’ and is a benchmark of internet technology improvement. With the characteristics of high speed and high bandwidth utilization ratio, P2P application is a part of human life now. Each of the user equipments is able to be not only a client but also a server. Further, each of the user equipment is able to download data blocks while uploads data blocks to the other user equipment. This mode really reduces the pressure of data transmission on servers.

Apparently, in the existing P2P network, the transmission of data blocks depends on the user's action of watching. That is, only the popular programs which are often downloaded can be gotten from the clients easily. The problem of this data blocks transmission mode includes that there are too many data blocks of the popular programs, while the data blocks of the unpopular programs are not sufficient. Until now, no efficient solution has been found to solve the above problems.

### SUMMARY OF THE INVENTION

The present invention provides solutions to the above problems. For example, the present invention provides new mechanisms for controlling the distribution of data blocks in P2P networks. In some embodiments, a stream data block is divided into pieces, and then the data block is distributed among stream server and user equipments using one piece as a unit. In the operating process of the system, the status of the distribution of the data block is collected continuously, and the usability of the stream media data is calculated according to the distribution of the data block and the resource-using information of the user equipments. This method is capable of providing highly concurrent customer service capability in large scale and highly improve the usability and reliability of the stream media data.

According to first aspect of the invention, a method of controlling the distribution of a data block in P2P networks is provided. The method comprises obtaining present distribution information of the data block, determining a desired distribution of said data block based on the present distribution information of said data block, and adjusting the distribution of said data block in said network based on said desired distribution of said data block.

According to second aspect of the invention, a method of adjusting the distribution of a data block in the end of a user equipment of P2P network is provided. The method comprises receiving an adjust command of the data block from a server end and adjusting the distribution of the data block according to the adjust command. The method further comprises reporting the present distribution of the data block of said user equipment to the server end.

According to third aspect of the invention, a controlling unit for controlling the distribution of a data block in P2P network is provided. The controlling unit comprises an obtaining unit of the distribution information for obtaining the present distribution information of the data block; a determining unit for determining a desired distribution of said data block based on the present distribution information of said data block, and an adjusting unit for adjusting the distribution of said data block in said network based on said desired distribution of said data block.

According to fourth aspect of the invention, an adjusting unit for adjusting the distribution of a data block in the end of a user equipment of P2P network is provided. The adjusting unit comprises a receiving unit for receiving an adjust command of the data block from a server end, an adjusting subunit for adjusting the distribution of the data block according to the adjust command, and a reporting unit of distribution information for reporting present distribution of the data block of said user equipment to the server end.

The data block disclosed herein can comprise a stream media file, and the data block can comprise a plurality of file pieces.

The technical solution provided in the present disclosure can be used to flexibly adjust the distribution of each of the file pieces of the data block according to the present distribution information of the data block and the resource-using information of the user equipments. Dummy file pieces can be deleted timely to release the resource of system; and the insufficient file pieces is able to be determined according to the system requirements, and copies of the insufficient file pieces is able to be increased to improve the download efficiency of the entire P2P network. The technical solutions of the present invention are easy to implement. Furthermore, network resource is able to be optimized through the execution of the technical solution of disclosed herein.

### BRIEF DESCRIPTION OF THE DRAWINGS

FIG. 1 shows a schematic diagram of a P2P network.

FIG. 2 shows a flowchart of a method of controlling the distribution of a data block in a P2P network according to some embodiments.

FIG. 3 shows a flowchart of a method of controlling the distribution of a data block in a P2P network according to some embodiments.

FIG. 4 shows a flowchart of a method of adjusting the distribution of a data block in a user equipment end in a P2P network according to some embodiments.

FIG. 5 shows a block diagram of a controlling unit for controlling the distribution of a data block in a P2P network according to some embodiments.

FIG. 6 shows a block diagram of a controlling unit for controlling the distribution of a data block in P2P network according to some embodiments.

FIG. 7 shows a block diagram of an adjusting unit for adjusting the distribution of a data block in a user equipment end in a P2P network, according to some embodiments.

Other features and advantages of the present invention will become obvious in the following description of non-limiting exemplary embodiments, with reference to the appended drawings. Wherein, similar or same reference signs represent similar or same technical features/units (components).

### DETAILED DESCRIPTION OF EMBODIMENTS

Detailed description in accordance with some embodiments of the present invention is further provided with drawings as below.

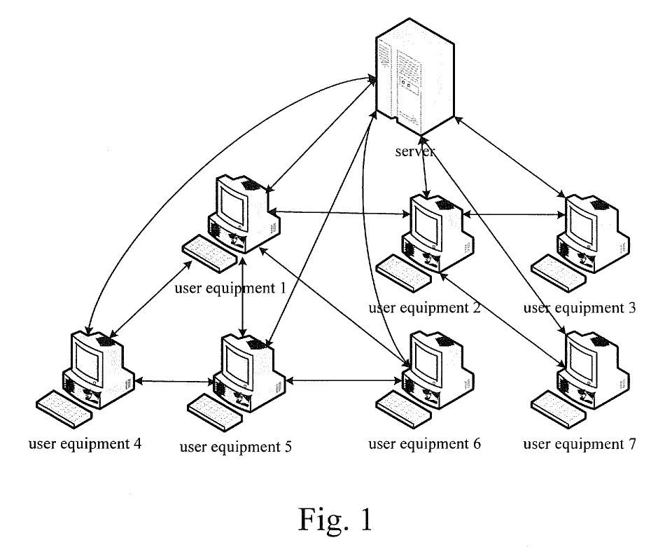

FIG. 1 illustrates a schematic diagram of a P2P network. The schematic diagram of the P2P network according to some embodiments of the present invention, as illustrated in FIG. 1, comprises a server and a plurality of user equipments. Seven user equipments are shown in FIG. 1. A person of ordinary skilled in the art would appreciate that any number of user equipments are able to be included.

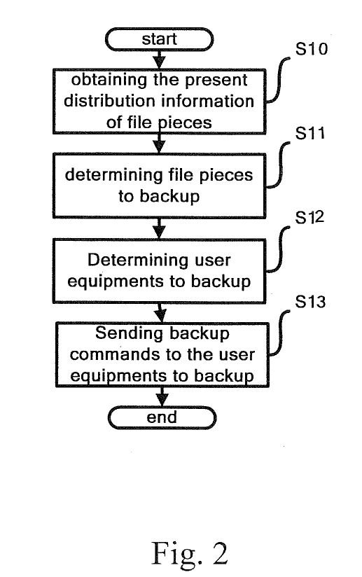

The first aspect of the present invention provides a method of controlling the distribution of a data block in P2P network. FIG. 2 is a flowchart providing a method of controlling the distribution of a data block in a P2P network according to some embodiments of the present invention. FIGS. 1 and 2 are able to be read together to provide more details.

In some embodiments, an integrate stream data block A is divided into N+1 file pieces and stored in a server. The file pieces are respectively tagged by the serial numbers A0, A1, A2, . . . and AN. To be clear and concise, the servers are not differentiated by their categories. A person ordinary skilled in the art would appreciate that servers in P2P network are able to comprise one or more stream media servers, and the program data block transmitted in the network is able to be stored in at least one of these stream media servers. The file pieces stored in each of the user equipments in this network, as an example, are shown in table 1 to below:

TABLE 1

| user equipment number | file pieces stored |
|---|---|
| user equipment 1 | A0, A1, A3, . . . and AN |
| user equipment 2 | A0, A3, A4, . . . and AN |
| user equipment 3 | A3, A4, A5, . . . and AN |
| . . . | . . . |
| user equipment M | A1, A3, A5, . . . and AN |

In step S10, the server obtains the present distribution information of data block A. The data block is able to be divided into a plurality of file pieces. The step S10 is able to obtain the present distribution information of each of said plurality of file pieces. As known to people skilled in the art, each of the user equipments in the P2P system is able to generate an information list of data block automatically. The information list is able to indicate all the data blocks stored in the present user equipment, and is able to be shown by file piece. When an user equipment receives a download request of a data block from another connected user equipment, the user equipment is able to first check whether that data block is in the information list, and then determine whether the connected user equipment is allowed to download the data block. In this embodiment, user equipments is able to be required to upload its information list to the server periodically. Then the server is able to know the corresponding file pieces of user equipments timely. For example, after receiving the information list from user equipment 1, the server is able to know that file pieces A0, A1, A3, . . . and AN are stored in user equipment 1. By periodically updating the information list of the user equipments having the data block, the server is able to get the corresponding relationship between to each file piece and its corresponding user equipments. The information list of the file pieces in this embodiment is shown in table 2 below:

TABLE 2

| File Piece Number | User equipments comprising the file piece |
|---|---|
| A0 | User equipment 1, User equipment 2, . . . |
| A1 | User equipment 1, . . . , and user equipment M |
| A2 | N/A |
| . . . | . . . |
| AN | User equipment 1, User equipment 2, |
| | User equipment 3, . . . , and User equipment M |

Next, Step 11 determines the file pieces to be adjusted based on the distribution information of the above file pieces. This embodiment describes how to increase the number of the backup of file pieces in the user equipments. People skilled in the art understand that the download efficiency of the whole data block is able to be impacted by the insufficiency of some file pieces. Sometimes user has already download most of the data block, but still cannot watch the program due to lack of a few file pieces. One way to solve the above problem is to increase the file pieces which are stored in the user equipments in a smaller number. The method below is able to be utilized to determine the file pieces, whose number of copies stored in the user equipments is small, as the file pieces to backup:

1) Checking whether each of the file pieces has at least one backup copy in the user equipments. That is to say, check whether the file pieces stored in all of the user equipments consist a complete data block. If not, the file pieces that are not stored in any of the user equipments (the missing file pieces) are determined/identified as the file piece to backup. Take the information list of the file pieces in the above Table 2 as an example, there is no backup copy of the file piece A2 in any of the user equipments. Thus, the file piece A2 is determined as a file piece for backup.

2) Determining the file piece, whose number of copies is less than a predetermined threshold number, as the file piece to backup. For example, it is forecasted that the required seed number of every file piece, according to the number of the user equipments in the system, and the predetermined threshold number is able to be set equal to the required seed number. If it is assumed that the predetermined threshold number is 50 in this embodiment, all the file pieces, whose number of backup copies is less than 50 in the user equipments, should be treated as the file pieces to backup. Various modifications can be made to the above method for determining the file pieces to backup. For example, the file pieces, whose number of backup copies is much less than other file pieces, is determined as file pieces to backup. For example, in this embodiment, the number of file piece A0 is 73. The number of file piece A1 is 62. The number of file piece A3 is 5 . . . . And the number of file piece AN is 34. In such case, file piece A3 should be determined as the file piece to backup. People skilled in the art can understand that the above methods of determining the file pieces to backup do not limit the scope of the appended claims.

Furthermore, the backup copies of the file pieces should be increased in some cases. For example, when the downloading expectation shows that the downloading rate of a data block will be highly increased in the future, the backup file pieces of this data block should be increased. Otherwise, the system resource is able to be occupied too much at the downloading peak, and the network jam is likely to occur. In an example, it is assumed that the statistical result shows that 100 audiences had downloaded data block A at the first day, and 200 audiences had downloaded data block A at the second day. The forecasted audience number of the third day is 600, based on the historical audience-date curve. It is further assumed that, to ensure the stable download, the number of the user equipments, which can provide the copy of the data block, cannot be less than k (k is a known constant determined according to the historical records). Since the system cannot meet above requirements, the numbers of the backup copies of all the file pieces in the data block need to be increased. Thus, all the file pieces of this data block is able to be determined as the file pieces to backup.

Next, Step S12 determines which user equipments are used to perform the backup of the file pieces that need a backup according to present resource information. The resource information is able to comprise occupancy factor of CPU, network bandwidth, and available storage space. The resource information of the user equipments that do not contain file pieces that need a backup is calculated and determined. The resource information determined is able to be used as a factor for sorting the user equipments that are selected for performing the backup. The user equipments that have more available system resource are able to be determined as the user equipments to perform the backup.

Following is an example illustrating the above scheme, it is assumed that the file piece A2 is a file piece that needs a backup, which is determined in the Step S10, three more copies of file pieces A2 need a backup, and there is no file piece A2 in user equipments 1-5. In this case, respective system resource information of each of the user equipments 1-5 is able to be calculated according to corresponding parameters in the system resource and their weights. The parameters/factors that are able to be considered include: whether the user equipment needs to watch/use the program data block A (the corresponding weight is assigned 10000); available storage space remained, the number of file pieces that can be stored, (the corresponding weight is assigned 100); whether the CPU is available (the corresponding weight is assigned 10); whether the network speed reaches a predetermined value (the corresponding weight is assigned 1). The resource information and calculated results of the user equipments are shown in Table 3 below.

TABLE 3

| | Whether the | | | Whether | |
|---|---|---|---|---|---|
| | user | Available | | Network | |
| User | equipment | Storage | CPU | Speed is | |
| Equipment | itself needs | Space | Available | High | |
| Number | data block A | Remained | or Not | Enough | Result |
| User | yes | 1 | yes | yes | 10111 |
| Equipment | | | | | |
| 1 | | | | | |
| User | no | 2 | yes | yes | 211 |
| Equipment | | | | | |
| 2 | | | | | |
| User | no | 1 | yes | yes | 111 |
| Equipment | | | | | |
| 3 | | | | | |
| User | no | 10 | yes | yes | 1011 |
| Equipment | | | | | |
| 4 | | | | | |
| User | no | 20 | yes | yes | 2011 |
| Equipment | | | | | |
| 5 | | | | | |

Based on the weight system described above, the user equipments are able to be sorted from high to low. The following order is generated based on the above system: user equipment 1, user equipment 5, user equipment 4, user equipment 2, and user equipment 3. Since three more backup copies of the file piece A2 are needed, user equipment 1, user equipment 5 and user equipment 4 are determined as the user equipments for a backup.

The resource information is able to further comprise other parameters. For example, whether the user equipment is operated by a user, whether the screen protection program is running, the number of user equipments connected with the user equipment, etc. Furthermore, other parameters that are not included in the resource information are also able to be used in the weighted statistics method. People skilled in the art will understand that the parameters and weights in the above statistics is able to be determined case by case and be selected flexibly in the implement process of the invention.

In Step S13, backup commands are sent to the user equipments for commanding the performance of a backup. In the above example, backup commands are issued to user equipment 1, user equipment 5 and user equipment 4 respectively to instruct them to backup file piece A2. After receiving the backup commands, the above user equipments respectively connect to the server to get the file piece A2. If other user equipments in the system have already contained this file piece, the user equipments that need a backup are also able to connect directly to these user equipments containing the file pieces. A person skilled in the art would appreciate that any other ways of obtaining the desired file pieces are applicable so long as the systems described above are able to find/locate the file pieces.

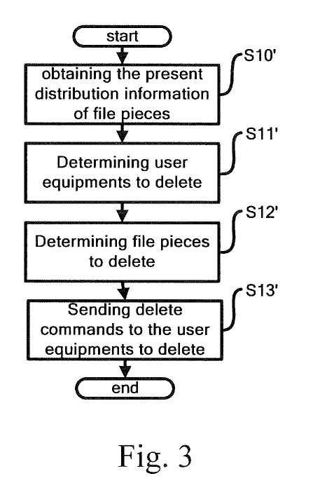

FIG. 3 is a flowchart showing a method of controlling the distribution of a data block in P2P networks according to some embodiments. FIG. 1 and FIG. 3 are able to be read together. In some embodiments, the data blocks consume too much system resource and some backup copies need to be deleted.

In an example, it is assumed that every complete stream data block is divided into file pieces and is stored in the system. For Example, the stream data block A is divided into N+1 file pieces. The file pieces are tagged respectively by the serial numbers A0, A1, A2, . . . and AN, and stored in a server. To be simple, it is assumed that data block A, C, D and E are stored in above network. File pieces A1, A2, A3, C1, C2, C3, C4, D1, D2, D3, . . . and E4 are stored in user equipment 1. In Step S10′, the server obtains the distribution information of the file pieces. People who skilled in the art would appreciate that each of the user equipments in the P2P system is able to generate an information list of the data block automatically. The information list shows all the data blocks stored in the user equipment and the information is usually provided by file pieces. When receiving a downloading request of the data block from other connected user equipment, the user equipment is able to check the information list first to know whether the data block is contained in itself, and then determine whether the connected user equipment is allowed to download the data block. In this case, the user equipment is able to be required to upload the information list of data blocks to the server periodically to inform the server which file pieces are contained in the user equipment. For example, by receiving the information list from user equipment 1, the server obtains the information indicating that the user equipment 1 contains the file pieces A1, A2, A3, C1, C2, C3, C4, D1, D2, D3, . . . and E4. By collecting the information lists of data block from all of the user equipments, the server is able to get the relationship between each of the user equipments and the corresponding file pieces contained therein.

Next, Step S11′ determines the files in which of the user equipments to be deleted. The determination is able to be base on the distribution information of file pieces described above. Based on the resource information of each of the user equipments, the server is able to determine which of the user equipments is highly loaded and the file contained there within is able to be deleted. In the following Step S12′, file pieces that is to be deleted is determined. One way to determine the files in which of the user equipments to be deleted is based on the storage space of the user equipments, which contain the file pieces. If the used storage space is more than a certain value, the user equipment is able to be determined as the user equipment having files for deletion. Other parameters related to resource, like occupancy factor of CPU, network bandwidth, and available storage space of user equipment are also to be considered. Of course, the parameters that are not related to resource information are also able to be considered, for example, the downloading status of the file piece.

Next, Step S12′ determines which file pieces to be deleted corresponding to each of the user equipments having files for deletion. The determination is able to be based on the related information of the file pieces in the user equipments having file for deletion. The downloading frequency of each of the file piece in the user equipments having files for deletion is calculated. Next, all the file pieces in the user equipment are sorted. The file pieces with lower using frequency are able to be determined as the file pieces for deletion.

In an example, it is assumed that user equipment 1 is a user equipment having files for deletion. The user equipment 1 is able to contain file pieces A1, A2, A3, C1, C2, C3, C4, D1, D2, D3, . . . and E4. In this example, it is further assumed that three file pieces are needed to be deleted. Moreover, it is assumed that file piece E4 is a file piece stored by the requirement of the server, the last time of using file piece A is three days ago, the last time of using data block D is one day ago, and the user of the user equipment is watching the program of data block C now.

In such example, using efficiencies of the above file pieces is calculated based on the parameters in the resource information and their corresponding weights. For example, the rating of the use efficiency equals to whether the user equipment is watching the program of the file piece times 10000 plus whether the file piece is being downloaded times 5000 plus whether the storage of the file piece is required by the server times 1000 minus the number of days from last usage. The ratings of the using efficiencies below are able to be obtained using the above formula:
data block A: A1=−3; A2=−3; A3=−3; A4=−3;
data block C: C1=10000; C2=10000; C3=15000; C4=15000;
data block D: D1=−1; D2=−1; D3=−1; D4=−1;
data block E: E4=1000.

The file pieces are able to be sorted by the rating from low to high, and the order for release below is able to be obtained: A1, A2, A3, A4, D1, D2, D3, D4, E4, C1, C2, C3, and C4. Since three file pieces need to be deleted from user equipment 1, the file piece A1, file piece A2 and file piece A3 are able to be determined as the file pieces for deletion.

People skilled in the art would understand that the parameters and their corresponding weights for statistic calculation are able to be determined case by case based on practical situations, and should not be limited by the examples in this embodiment. User equipment 1 is taken as an example to describe how to determine the user equipments having files for deletion and the file pieces for deletion therein. There are usually more than one user equipments having files for deletion in the system. The calculation and determination is able to be performed in each of the user equipments respectively.

In Step S13′, delete commands are sent to all of the user equipments having files for deletion. For example, a delete command is sent to user equipment 1, and asks it to delete file piece A1, file piece A2, and file piece A3. After receiving the delete command, user equipment 1 deletes file piece A1, file piece A2, and file piece A3. The user equipment is able to update corresponding system files after the file deletion.

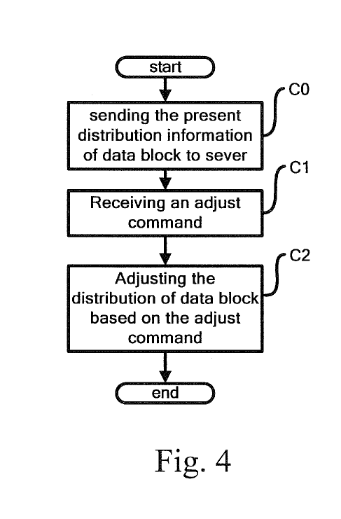

A second aspect of the present invention provides a method of adjusting the distribution of a data block in the user equipment end in P2P networks. FIG. 4 is a flowchart showing the method of adjusting the distribution of a data block in the user equipment end in P2P networks according to some embodiments. FIG. 1 and FIG. 4 are able to be read together. The user equipment 1 in FIG. 1 is taken as an example.

In some embodiments, Step C0 reports the distribution information of the data block in the user equipment to the server. In this embodiment, the data block is able to be a stream media data block. The data block is able to comprise file pieces. For example, user equipment 1 reports to the server that user equipment 1 contains the file pieces A1, A3, A4 of a data block A, all the file pieces of data block C, and file piece E1. When user equipment reports the distribution information of the data block to the server, the user equipment is also able to report the resource information of the user equipment. Specifically, the resource information is able to comprise occupancy factor of CPU, network bandwidth, available storage space, and . . . etc.

In Step C1, user equipment 1 receives an adjust command from the server. The adjust command is able to comprise a backup command to ask user equipment 1 to get specific file pieces, or comprise a delete command to ask user equipment 1 to delete specific file pieces. It is assumed that user equipment 1 received the delete command which requires it to delete the file piece A3.

In step C2, user equipment 1 adjusts the distribution of the data block according to the adjust command. In this embodiment, file pieces A3 is deleted based on the delete command. After finishing deleting that file piece, user equipment 1 updates the information list of the data block in itself. People skilled in the art understand that, each of the user equipments in the P2P system is able to generate the information list of data block automatically. The information list shows all the data blocks contained in the user equipment and usually used file piece as the unit. Other methods to implement the above generation and updating are applicable. Furthermore, user equipment 1 is able to upload the updated information list of data blocks to the server after updating the information list of data blocks.

People skilled in the art understand that, the Step C1 is able to be finished before step C2 starts, but there is not strict order among all steps. User equipment 1 is able to update the information list of data block in itself to the server after receiving the upload command from the server. User equipment 1 is also able to upload the information list to the server periodically.

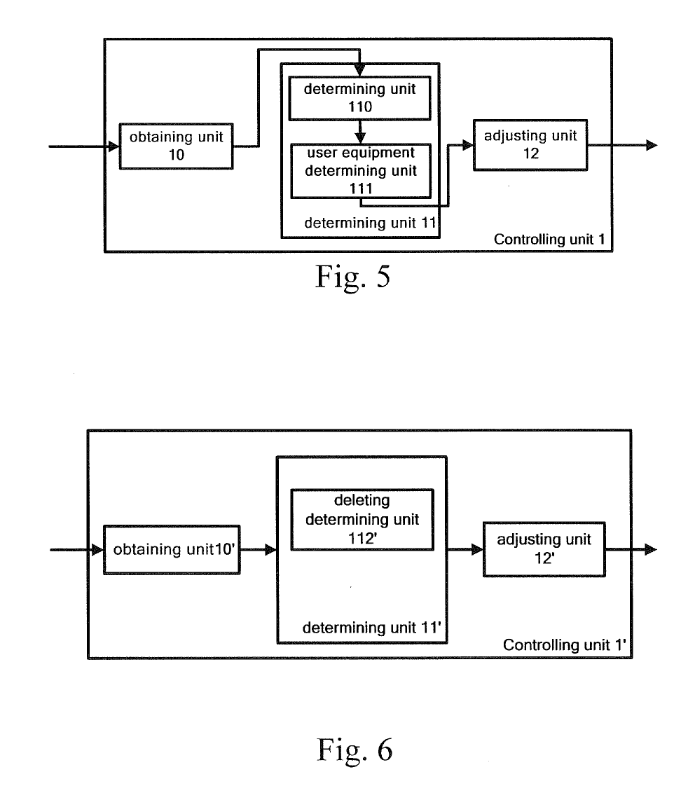

A third aspect of the present invention provides a controlling unit for controlling the distribution of a data block in P2P network. FIG. 5 shows a block diagram of a controlling unit for controlling the distribution of a data block in P2P networks according to some embodiments. FIG. 1 and FIG. 5 are able to be read together.

In some embodiments, controlling unit 1 comprises an obtaining unit 10, a determining unit 11, and an adjusting unit 12. In some embodiments, the determining unit 11 comprises a file pieces determining unit 110 and a user equipment determining unit 111.

In an example, it is assumed that an integrate stream data block A is divided into N+1 file pieces and stored in the server. The file pieces are able to be tagged respectively by the serial numbers A0, A1, A2, . . . and AN. The servers are able to be of various kinds. As known to people skilled in the art, servers in P2P network are able to comprise one or more stream servers and the program data block transmitted in the network is stored in at least one of the stream servers. The file pieces stored in each of the user equipments in this network are shown in table 4 below:

TABLE 4

| user equipment number | file pieces |
|---|---|
| user equipment 1 | A0, A1, A3, . . . and AN |
| user equipment 2 | A0, A3, A4, . . . and AN |
| user equipment 3 | A3, A4, A5, . . . and AN |
| . . . | . . . |
| user equipment M | A1, A3, A5, . . . and AN |

The obtaining unit 10 is able to be utilized to obtain the present distribution information of data block A. For the data block divided into a plurality of file pieces, the obtaining unit 10 is able to be utilized to obtain the present distribution information of each of the plurality of file pieces. As known to people skilled in the art, each of user equipments in the P2P system is able to generate an information list of data block automatically. The information list is able to indicate all the data block stored in the present user equipment and is usually shown using file piece as the unit. When an user equipment receives a download request of a data block from another connected user equipment, the user equipment is able to check whether that data block is in the information list first, and then determine whether the connected user equipment is allowed to download the data block. In this example, user equipments are able to be required to upload its information list to the server periodically. Then the server can know the corresponding file pieces of user equipments timely. For example, after receiving the information list from user equipment 1, the server is able to know that file pieces A0, A1, A3, . . . and AN are stored in user equipment 1. By updating the information list of the user equipment having the data block periodically, the obtaining unit 10 is able to obtain the corresponding relationship between each file piece and its corresponding user equipments. The information list of the file pieces in this embodiment is shown in Table 5 below:

TABLE 5

| File Piece Number | user equipments comprising the file piece |
|---|---|
| A0 | user equipment 1, user equipment 2, . . . |
| A1 | user equipment 1, . . . , and user equipment M |
| A2 | NA |
| . . . | . . . |
| AN | user equipment 1, user equipment 2, |
| | user equipment 3, . . . , and user equipment 1 |

The obtaining unit 10 is able to send the obtained distribution information of file pieces to the determining unit 11.

The file pieces determining unit 110 in the determining unit 11 determines which file pieces to adjust based on the distribution information of above file pieces. This embodiment describes how to increase the efficiency of backup of file pieces in the user equipments. People skilled in the art understand that the download efficiency of the whole data block is able to be impacted by the insufficiency of some file pieces. Sometimes user has already download most of the data block, but still cannot watch the program due to the lack of a few file pieces. One way to solve the above problem is to increase file pieces which are stored in the user equipments in smaller number. The method below is able to be utilized by the file pieces determining unit 110 to determine the file pieces, whose number of copies stored in the user equipments is small, as the file pieces to backup:

1) The file pieces determining unit 110 is able to be utilized to check whether each of the file pieces has backup copies in the user equipments. That is to say, check whether the file pieces stored in all the user equipments can consist a complete data block. If not, the file piece, which is not stored in the user equipments, is determined as the file piece to backup. Take the information list of the file pieces in above table as an example, there is no backup copy of the file piece A2 in any user equipment. Thus, the file pieces determining unit 110 determines the file piece A2 as the file piece to backup.

2) The file pieces determining unit 110 is able to be utilized to determine the file piece, whose number of copies is less than a predetermined threshold number, as the file pieces to backup. For example, it is forecasted that the required seed number of every file piece according to the number of the user equipments in the system, and the predetermined threshold number is set equal to the required seed number. If it is assumed that the predetermined threshold number is 50 in this embodiment, all the file pieces, whose number of backup copies is less than 50 in the user equipments, is able to be treated as the file pieces to backup. Various modifications can be made to the above method of determining the file pieces to backup. For example, the file pieces determining unit 110 is able to determines the file pieces, whose number of backup copies is much less than other file pieces, as the file pieces to backup. For example, in this embodiment, the number of file piece A0 is 73, the number of file piece A1 is 62, the number of file piece A3 is 5, . . . , and the number of file piece AN is 34. In such case, file piece A3 is able to be determined as the file piece to backup. People skilled in the art can understand that the above methods for determining the file pieces by the file pieces determining unit 110 to backup does not limit the scope of the claims of the present invention.

Furthermore, the backup copies of the file pieces are able to be duplicated in some cases. For example, when the downloading expectation shows the downloading rate of a data block will be highly increased in the future, the backup file pieces of this data block can be increased. Otherwise, the system resource is able to be occupied too much at the downloading peak resulting in network jam. Thus, the file pieces determining unit 110 is able to define this category of file pieces of as the file pieces to backup. In an example, it is assumed that the statistical result shows that 100 audiences had downloaded data block A at the first day, and 200 audiences had downloaded data block A at the second day. The forecasted audience number at the third day is 600 based on the historical audience-date curve. It is further assumed that, to ensure a stable download, the number of the user equipments, which can provide the copy of the data block, cannot be less than k (k is a known constant determined according to the historical records). Since the system cannot meet the above requirements, the backup copies of all the file pieces in the data block need to be increased. Thus, all the file pieces of this data block is able to be determined as the file pieces for a backup.

Next, the user equipment determining unit 111 is able to determine user equipment for a backup corresponding to every file piece to backup, according to the present resource information. The resource information may comprise occupancy factor of CPU, network bandwidth and available storage space. The user equipment determining unit 111 is able to calculate the resource information of the user equipments not having the file pieces to backup, and then sort the user equipments by the calculated results. The user equipments having more available system resource is able to be determined as the user equipments for a backup.

In an example, it is assumed that the file piece A2 is a file piece for a backup and three more copies of file piece A2 need for a backup. There is no file piece A2 in user equipments 1-5. First, the user equipment determining unit 111 is able to calculate the system resource information of user equipment 1-5 respectively according to parameters in the system resource and their weights. The parameters are able to be considered include: whether the user equipment needs to use the program data block A (the corresponding weight is 10000); available storage space remained, in other words, the number of file pieces that can be stored (corresponding weight is 100); whether CPU is available (corresponding weight is 10); whether network speed is up to a predetermined value (corresponding weight is 1). The resource information and calculating result of the user equipments are shown in Table 6 below.

TABLE 6

| | Whether the | | | Whether | |
|---|---|---|---|---|---|
| | user | available | | network | |
| User | equipment | storage | CPU | speed is | Calcu- |
| equipment | itself needs | space | available | high | lating |
| number | data block A | remained | or not | enough | Result |
| user | yes | 1 | yes | yes | 10111 |
| equipment | | | | | |
| 1 | | | | | |
| user | no | 2 | yes | yes | 211 |
| equipment | | | | | |
| 2 | | | | | |
| user | no | 1 | yes | yes | 111 |
| equipment | | | | | |
| 3 | | | | | |
| user | no | 10 | yes | yes | 1011 |
| equipment | | | | | |
| 4 | | | | | |
| user | no | 20 | yes | yes | 2011 |
| equipment | | | | | |
| 5 | | | | | |

The user equipment determining unit 111 is able to sort the user equipments based on the calculated result from high to low, and gets the following order: user equipment 1, user equipment 5, user equipment 4, user equipment 2, and user equipment 3. In such case, since 3 more backup copies of the file piece A2 are needed, user equipment 1, user equipment 5 and user equipment 4 are determined as the user equipments for a backup.

Besides, the resource information can further comprise other parameters. For example, whether the user equipment is operated by user, whether the screen protection program is running, the number of user equipments connected with the user equipment, etc. Furthermore, other parameters not included in the resource information can also be used in the weighted statistics method executed by the user equipment determining unit 111. People skilled in the art should understand that the parameters and weights in above statistics can be determined case by case and be selected flexibly in the implement process of the invention.

The adjusting unit 12 is able to sends backup commands to the user equipments for a backup. In this embodiment, backup commands are able to be issued to user equipment 1, user equipment 5 and user equipment 4 respectively to instruct them to backup file piece A2. After receiving the backup commands, the above user equipments respectively connect to the server to get the file piece A2. If other user equipments in the system have already contained this file piece, the user equipments to backup can also connect directly to these user equipments containing the file pieces.

FIG. 6 shows a block diagram of a controlling unit for controlling the distribution of a data block in P2P networks according to some embodiments of the invention. FIG. 1 and FIG. 6 are able to be read together. In some embodiments, the data block consumes too much system resource and some backup copies need to be deleted. The control unit comprises an obtaining unit 10′, a determining unit 11′ and an adjusting unit 12′. Preferably, the determining unit 11′ can further comprise a delete determining unit 112′.

In some examples, it is assumed that every complete stream data block is divided into file pieces and is stored in the system. For Example, the stream data block A is divided into N+1 file pieces. The file pieces are tagged respectively by the serial numbers A0, A1, A2, . . . , and AN, and are stored in the server. To be simple, it is assumed that data block A, C, D and E are stored in the above network. File pieces A1, A2, A3, C1, C2, C3, C4, D1, D2, D3, . . . , and E4 are stored in user equipment 1.

The obtaining unit 10′ is able to obtain the distribution information of the file pieces. A people skilled in the art would appreciate that each of the user equipments in the P2P system is able to generate an information list of the data block automatically. The information list is able to show all the data blocks stored in the user equipment and the information is usually using file piece as an unit. When receiving a downloading request of the data block from other connected user equipments, the user equipment is able to check the information list first to know whether the data block is contained in itself, and then determine whether the connected user equipment is allowed to download the data block. In some embodiments, the user equipment is able to be required by the obtaining unit 10′ to upload the information list of data blocks to the server periodically to inform the server of what file pieces are contained in the user equipment. For example, by receiving the information list from the user equipment 1, the server obtains the information showing that the user equipment 1 has the file pieces A1, A2, A3, C1, C2, C3, C4, D1, D2, D3, . . . and E4. By collecting the information lists of data block from all the user equipments, the obtaining unit 10′ is able to obtain the relationship between each of the user equipments and the corresponding file pieces contained therein.

Then, the delete determining unit 112′ determines user equipments having files for deletion base on above distribution information of file pieces. After knowing the storage status of each of the user equipments, the delete determining unit 112′ is able to determine which of the user equipments are highly loaded based on the resource information of each of the user equipments. The user equipments that are highly loaded is selected as the user equipments having files for deletion. Subsequently, file pieces that are selected to be deleted is determined. One factor to determine which of the user equipments having files for deletion is by checking the available storage space used by the file pieces in the user equipments. If the used storage space is more than a defined value, the specific user equipment is defined as a user equipment having file for deletion. Other factors related to resources, like network bandwidth, occupancy factor of CPU, and available storage space of user equipments are also able to be considered when determining which of the user equipments are the user equipments having files for deletion. Other factors that are not related to resource information are also able to be considered, for example, the downloading status of the file piece.

Next, the delete determining unit 112′ determines which file pieces to delete based on the related information of the file pieces corresponding to each of the user equipments that have files for deletion. In some examples, the delete determining unit 112′ first calculates the downloading frequency of each file piece in the user equipments having files for deletion, sorts all the file pieces in the user equipments according to the calculated results, and determines the file pieces for deletion based on lower using frequency.

In some cases, it is assumed that the user equipment 1 is a user equipment having files for deletion which contains file pieces A1, A2, A3, C1, C2, C3, C4, D1, D2, D3, . . . , and E4. It is also assumed that three file pieces need to be deleted. Moreover, it is assumed that the file piece E4 is a file piece stored by requirements of the server. Furthermore, it is assumed that the last time of using file piece A is three days ago, the last time of using data block D is one day ago, and the user of the user equipment is watching the program of data block C now.

At first, delete determining unit 112′ calculates the using efficiency of the above file pieces based on the parameters in the resource information and their corresponding weights. For example, the rating of use efficiency equals to whether the user equipment is watching the program of the file piece times 10000 plus whether the file piece is being download times 5000 plus whether the storage of the file piece is required by the server times 1000 minus the number of days from last usage. The ratings of using efficiencies below are able to be obtained after calculated by the above formula:
data block A: A1=−3; A2=−3; A3=−3; A4=−3;
data block C: C1=10000; C2=10000; C3=15000; C4=15000;
data block D: D1=−1; D2=−1; D3=−1; D4=−1;
data block E: E4=1000.

The file pieces are sorted by the rating from low to high, and the order for file releasing or deleting is listed below: A1, A2, A3, A4, D1, D2, D3, D4, E4, C1, C2, C3, and C4. Since three file pieces need to be deleted from user equipment 1, file piece A1, file piece A2 and file piece A3 are able to be determined as the file pieces for deletion, which is determined by the delete determining unit 112′.

People skilled in the art should understand that, the parameters/factors and its corresponding weights for the above statistic calculation are able to be defined case by case based on practical situations, and should not be limited by the examples in the embodiments. User equipment 1 is taken as an example to describe how to determine the user equipments having files for deletion and the file pieces for deletion therein. More than one user equipments having files for deletion in the system are applicable. The determination and sorting are able to be performed in each of the user equipments respectively.

Next, the adjusting unit 12′ is able to send delete commands to all the user equipments for file deletion. For example, a delete command is sent to the user equipment 1, and asks it to delete file piece A1, file piece A2, and file piece A3. After receiving the delete command, the user equipment 1 deletes file piece A1, file piece A2, and file piece A3, and update corresponding system file. Other ways to implement above methods are applicable.

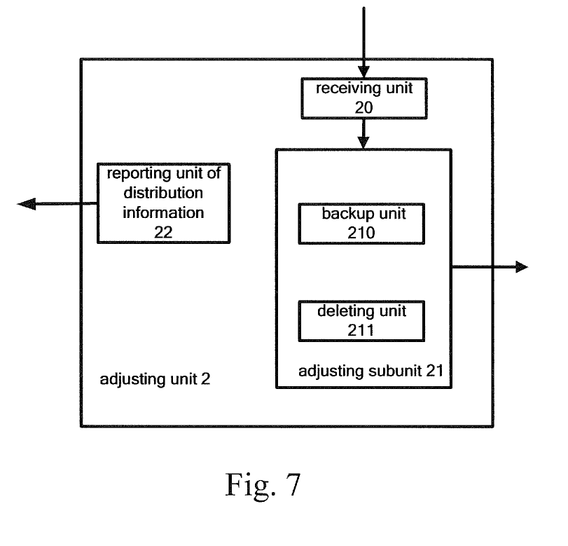

A fourth aspect of the present invention provides an adjusting unit for adjusting the distribution of a data block in the user equipment end in P2P networks. FIG. 7 is a block diagram showing the adjusting unit for adjusting the distribution of a data block in the user equipment end in P2P networks according to some embodiments of the present invention. FIG. 1 and FIG. 7 are able to be read together. The user equipment 1 in FIG. 1 is used as an example. The adjusting unit 2 comprises a receiving unit 20, an adjusting subunit 21 and a reporting unit of distribution information 22. The adjusting subunit 21 further comprises a backup unit 210 and/or a deleting unit 211.

The reporting unit of distribution information 22 is able to report the distribution information of the data block in the present user equipment to the server. The reporting unit of distribution information 22 is able to upload the distribution information of data block in the user equipment 1 to the server after receiving an upload command from the server or upload to the server periodically. In some embodiments, the data block is able to be a stream data block. The data block is able to comprise file pieces. For example, user equipment 1 reports to the server that the user equipment 1 contains the file pieces A1, A3, A4 of data block A, all the file pieces of data block C and file piece E1. Furthermore, the report unit of distribution information 22 is able to report the resource information of the present user equipment, while reporting the distribution information of the data block to the server. The resource information is able to comprise occupancy factor of CPU, network bandwidth, available storage space, etc.

The receiving unit 20 is able to be utilized to receive an adjust command from the server. The adjust command is able to comprise a backup command to ask the user equipment 1 to get specific file pieces or comprise a delete command to ask user equipment 1 to delete specific file pieces. In an example, the user equipment 1 receives the delete command which requires the user equipment 1 to delete file piece A3.

The adjusting subunit 21 is able to adjust the distribution of the data block according to the adjust command. In the above example, it means to delete file pieces A3 based on the delete command. After finishing deleting that file piece, the adjust subunit 21 is able to update the information list of the data block in itself. People skilled in the art understand that each of the user equipments in the P2P system is able to generate an information list of data block automatically. The information list shows all the data blocks contained in a user equipment, and usually uses file piece as an unit. The implementation of the above generation and update are able to be performed through various ways. Furthermore, the adjusting subunit 21 is able to upload the updated information list of data blocks to the server after updating the information list of data blocks.

The user equipment 1 is able to upload the data block distribution information of the present user equipment to the server after receiving the upload command from the server, or upload to the server periodically.

Although the embodiments of the present invention have been described above, it should be understood by those skilled in the art that various modifications can be made without departing from the scope and spirit of the scope of the appended claims.

What is claimed is:

1. A method for controlling the distribution of a data block in P2P network, wherein, the method comprises:
a. obtaining the present distribution information of the data block;
b. determining a desired distribution of said data block, based on the present distribution information of said data block;
c. adjusting the distribution of said data block in said network based on said desired distribution of said data block.

2. A method according to claim 1, wherein, said data block comprises a plurality of file pieces, said step a further comprises:
obtaining the present distribution information of the file pieces, which comprises said present distribution information of each of said plurality of file pieces;
said step b comprises:
determining file pieces to adjust and user equipments to adjust corresponding to each of said file pieces to adjust, based on the present distribution information of the file pieces;
and said step c comprises;
sending adjust commands to said user equipments to adjust respectively, said adjust command is for instructing said user equipment to adjust to adjust said file pieces to adjust corresponding to said user equipment to adjust.

3. A method according to claim 2, wherein, said file pieces to adjust comprises file pieces to backup, and said step b further comprises:
b1. determining said file pieces to backup based on said present distribution information of each of said file pieces.

4. A method according to claim 3, wherein, said step b1 comprises:
determining the file pieces in said plurality of file pieces, which are not stored in user equipments, as the file pieces to backup.

5. A method according to claim 3, wherein, said step b1 comprises:
determining the file pieces in said plurality of file pieces, whose quantity is less than a predetermined threshold number, as the file pieces to backup.

6. A method according to claim 3, wherein, said step b1 comprises:
determining the file pieces to backup according to downloading expectations.

7. A method according to claim 3, wherein, said user equipments to adjust comprise user equipments to backup, said step b further to comprises:
b2. determining the user equipments to backup corresponding to each of said file pieces to backup, according to present resource information of the user equipments, said user equipments to backup are for backuping said file pieces to backup;
and said step c further comprises:
sending backup commands to said user equipments to backup, said backup commands are for instructing said user equipments to backup to backup said file pieces to backup.

8. A method according to claim 7, wherein, said resource information comprises at least one of network bandwidth, occupancy factor of CPU and available storage space.

9. A method according to claim 2, wherein, said file pieces to adjust comprise file pieces to delete, said step b further comprises:
b1′. determining the user equipments to delete and the file pieces corresponding to each of the user equipment to delete, according to the present resource information;
and said step c further comprises:
sending delete commands to said user equipments to delete, said delete command is to instruct said user equipment to delete to delete said file pieces to delete.

10. A method according to claim 1, wherein, said data block is a stream media file.

11. A method for adjusting the distribution of a data block in the end of user equipments in P2P networks, wherein, the method comprises:
receiving an adjust command of the data block from a server end;
adjusting the distribution of the data block according to the adjust command;
wherein, the method further comprises:
reporting the present distribution of the data block of said user equipment to the server end.

12. A method according to claim 11, wherein, said adjust command comprises a backup command and/or a delete command.

13. A method according to claim 11, wherein, said data block comprises a plurality of file pieces.

14. A method according to claim 11, wherein, said data block is a stream media file.

15. A controlling unit for controlling the distribution of a data block in P2P networks, wherein, the controlling unit comprises:
an obtaining unit of the distribution information, for obtaining the present distribution information of the data block;
a determining unit, for determining a desired distribution of said data block based on the present distribution information of said data block;
an adjusting unit, for adjusting the distribution of said data block in said network based on said desired distribution of said data block.

16. A controlling unit according to claim 15, wherein, said data block comprises a plurality of file pieces, said obtaining unit of the distribution information is further used for obtaining the present distribution information of the file pieces, said distribution information of the file pieces comprise said present distribution information of each of said plurality of file pieces;
said determining unit is for determining file pieces to adjust and user equipments to adjust corresponding to each of said file pieces to adjust, based on the present distribution information of the file pieces;
and said adjusting unit is for sending adjust commands to said user equipments to adjust respectively, said adjust command is to instruct said user equipment to adjust to adjust said file pieces to adjust corresponding to said user equipment to adjust.

17. A controlling unit according to claim 16, wherein, said file pieces to adjust comprises file pieces to backup, said determining unit further comprises a file pieces determining unit, and said file pieces determining unit is for determining said file pieces to backup based on said present distribution information of each of said file pieces.

18. A controlling unit according to claim 17, wherein, said file pieces determining unit is also used for determining the file pieces in said plurality of file pieces, which are not stored in said user equipments, as the file pieces to backup.

19. A controlling unit according to claim 17, wherein, said file pieces determining unit is also used for determining the file pieces in said plurality of file pieces, whose quantity is less than a predetermined threshold number, as the file pieces to backup.

20. The control unit according to claim 17, wherein, said file pieces determining unit is also used for determining the file pieces to backup according to the downloading expectations.

21. A controlling unit according to claim 17, wherein, said user equipments to adjust comprise user equipments to backup, said determining unit further comprises a user equipment determining unit:
said user equipment determining unit is for determining the user equipment to backup corresponding to each of said file pieces to backup according to the present resource information of the user equipments, said user equipments to backup are for backuping said file pieces to backup;
and said adjust unit is also used for sending backup commands to said user equipments to backup, said backup command is for instructing said user equipments to backup to backup said file pieces to backup.

22. A controlling unit according to claim 21, wherein, said resource information comprises at least one of network bandwidth, occupancy factor of CPU and available storage space.

23. A controlling unit according to claim 16, wherein, said file pieces to adjust comprise file pieces to delete, said determining unit further comprises a delete determining unit:
said delete determining unit is for determining user equipments to delete and the file pieces to delete corresponding to each of said user equipments to delete, according to the present resource information;
said determining unite is further used to send a delete command to said user equipments to delete, said delete command is to instruct said user equipments to delete to delete said file pieces to delete.

24. A controlling unit according to claim 15, wherein, said data block is a stream media file.

25. An adjusting unit for adjusting the distribution of a data block in the end of user equipments in P2P networks, wherein, the adjusting unit comprises:
a receiving unit for receiving an adjust command of the data block from a server end;
an adjusting subunit for adjusting the distribution of the data block according to the adjust command;
a reporting unit of distribution information for reporting the present distribution of the data block of said user equipment to the server end.

26. An adjusting unit according to claim 25, wherein, said adjusting subunit comprises a backup unit and/or a delete unit.

27. An adjusting unit according to claim 25, wherein, said data block comprises a plurality of file pieces.

28. An adjusting unit according to claim 25, wherein, said data block is a stream media file.
